(19) United States
(12) Patent Application Publication
(10) Pub. No.: US 2007/0083851 A1
(43) Pub. Date: Apr. 12, 2007

(54) TEMPLATE-BASED MULTIMEDIA EDITOR AND EDITING METHOD THEREOF

(75) Inventors: Chih Ming HUANG, Taoyuan (TW); Chin Shun HUANG, Changhua (TW); Pei Yu TSAI, Taipei (TW); Ko Ching WU, Taipei (TW)

Correspondence Address: SNELL & WILMER, 400 EAST VAN BUREN, ONE ARIZONA CENTER, PHOENIX, AZ, 85004-2202, US

(73) Assignee: MODA CO., LTD., Taipei (TW)

(21) Appl. No.: 11/463,171

(22) Filed: Aug. 8, 2006

(30) Foreign Application Priority Data
Oct. 6, 2005 (TW) 94134959

(51) Int. Cl. G06F 9/44

(52) U.S. Cl. 717/113

(57) ABSTRACT

A template-based multimedia editor and editing method are disclosed. The editor includes a template module, a material database, a converting mechanism, and a user interface. The template module has an interactive area and at least one template element. The template module includes at least one adjustable template parameter and the template element has at least one adjustable template element parameter. The material database has at least one material data including at least one adjustable material parameter. The converting mechanism is adapted to process a predetermined algorithm. The user interface provides a preview area for a user to edit the template module and material data. The user selectively adjusts the template parameter, the template element parameter, and the material parameter via the user interface, and selectively sets the template element parameter to define an interactive relationship between the template element and the interactive area, and associates a selected material data with the preview area via a drag-and-drop operation. The converting mechanism converts the template module and the material data into multimedia information based on the predetermined algorithm.

### CROSS REFERENCE TO RELATED APPLICATIONS

This application claims priority of Taiwan Patent Application Serial No. 094134959 entitled “TEMPLATE-BASED MULTIMEDIA EDITOR AND EDITING METHOD THEREOF,” filed on Oct. 6, 2005.

### FIELD OF THE INVENTION

The present invention relates to a multimedia editor and editing method thereof. More particularly, the present invention relates to a template-based multimedia editor and editing method for producing multimedia information.

### BACKGROUND OF THE INVENTION

As the electronic technology developed, digitalization was broadly implemented in various fields. The computer capable of processing digital signals had been one of the most popular digitalization applications. In addition, there are also digital cameras, digital recorders, digital televisions, digital music players, etc. However, difficulties arise with digitalization applications. For example, many encoding file formats are devised for the digital applications, such as digital image, digital audio, digital video, digital compression, etc. Even the text characters may be encoded in various ways, such as BIG5, Unicode, ASCII, etc. Editing of multi-media information raises the problems for format exchange between information of different format.

Recently, multimedia information has become popular to users due to conventional text or audio presentations not attracting users anymore. The multimedia information are expected to have higher quality and interactivity. The interactive multimedia applications are broadly used in interactive multimedia education, interactive multimedia websites, interactive multimedia Kiosks, and also in interactive multimedia video or programs. However, production of multimedia information usually involves of using complicated machines or software, which requires extensive trainings or knowledge. Further, understanding of the digital file formats and encodings are also required for users to manipulate their productions well.

The traditional editor is not convenient for users to perform their production of multimedia information easily. FIG. 1A and FIG. 1B are flowcharts illustrating a prior art method for editing multimedia information. Users need to analyze the data type for an appropriate process in the traditional editors. FIG. 1A shows two data types, i.e. image data 102 and text data 104. First, the user selects the image data converter 106 for the image data 102, such as GIF, JPG, BMP, PNG, PSD, etc. Even the files of the same type are sometimes different in format because of version or encoding differentiation. Similarly, the user needs to select the text data converter 108 for the text data 104. When number of the data converters becomes increased along with the file formats, the users are burdened with recognition complexity between these file formats. Further, the multimedia converter 109 outputs a proprietary file format 110 causing the file being difficult to be exchanged between users.

FIG. 1B shows another problem in traditional editor. First, the users select the required files, such as audio or video data, in step 112. These files are pre-processed via the procedures in FIG. 1A. In step 114, the users need to modify some source codes during the editing process. For example, the users should understand the HTML tags or other Script languages to produce the multimedia information. In step 116, the multimedia editor converts the file format according to the user-modified source code. At last, the multimedia information is produced in step 118.

In these interactive multimedia applications, the multimedia production typically involves different types of people working together, such as an editor, an educator, a photographer, a recorder, a director, an actor, etc. These people are usually not familiar with the above knowledge for multimedia information production, such as source code modification, difference/conversion between file formats. Hence, it is difficult and inefficient to produce the multimedia information. Some techniques are disclosed to cure part of problems but still other problems are left unsolved. For example, Taiwan patent number 420775, entitled “Interactive Multimedia Demonstration Software Editing System,” discloses an editing system to simplify the multimedia editing process via a scenario or theme file. However, the scenario file is merely a non-customizable background image and provides only demonstration rather than real-time interactive effect. Furthermore, it also produces the proprietary file format resulting in inconvenient exchange between users.

Therefore, it is advantageous to provide an interactive multimedia editor and editing method with user-friendly interface for producing high compatible file.

### SUMMARY OF THE INVENTION

A template-based multimedia editor and editing method are disclosed. The editor includes a template module, a material database, a converting mechanism, and a user interface. The template module has an interactive area and at least one template element. The template module includes at least one adjustable template parameter and the template element has at least one adjustable template element parameter. The material database has at least one material data including at least one adjustable material parameter. The converting mechanism is adapted to process a predetermined algorithm. The user interface provides a preview area for a user to edit the template module and material data. The user selectively adjusts the template parameter, the template element parameter, and the material parameter via the user interface, and selectively sets the template element parameter to define an interactive relationship between the template element and the interactive area, and associates a selected material data with the preview area via a drag-and-drop operation. The converting mechanism converts the template module and the material data into multimedia information based on the predetermined algorithm.

The template-based multimedia editing method includes the following steps. A template module is selected. The template module includes at least one adjustable template parameter, an interactive area, and at least one template element having at least one adjustable template element parameter. At least one material data, having at least one adjustable material parameter, is selected. The selected material data is associated with a preview area. The template parameter and the template element parameter are selectively adjusted. The template element parameter is selectively set to define an interactive relationship between the template element and the interactive area. The material parameter is selectively adjusted. Multimedia information is output according to the template module and the material data.

### BRIEF DESCRIPTION OF THE DRAWINGS

FIG. 1A and FIG. 1B are flowcharts illustrating a prior art method for editing multimedia information;

FIG. 2 is a block diagram illustrating a multimedia editor in accordance with one embodiment of the present invention;

FIG. 3 is a flowchart illustrating a multimedia editing method in accordance with one embodiment of the present invention;

FIG. 4 illustrates the template module shown in FIG. 2;

FIG. 5 illustrates the user interface shown in FIG. 2; and

FIG. 6 is a flowchart illustrating a multimedia editing method in accordance with another embodiment of the present invention.

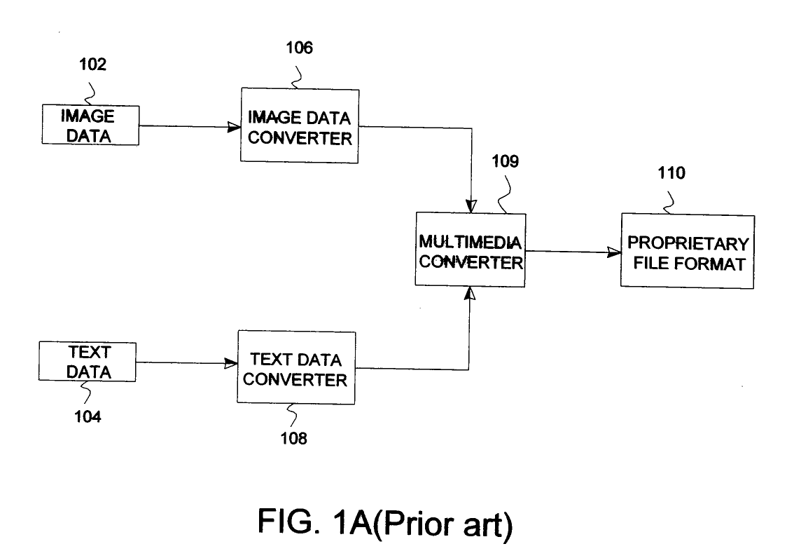

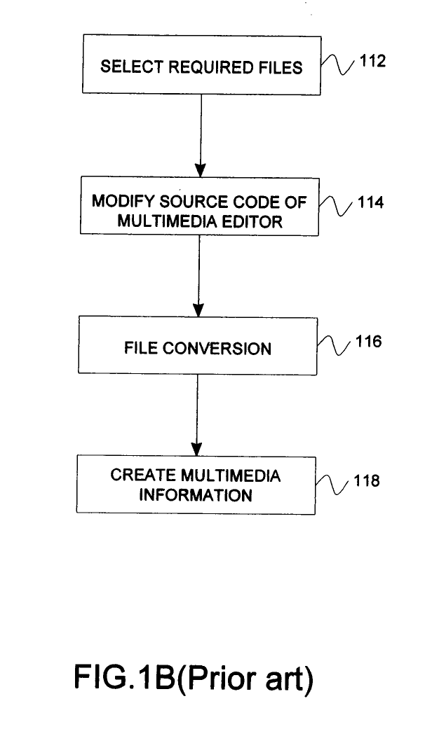

### DETAILED DESCRIPTION OF THE INVENTION

Terminology

The terminologies employed herein are for the purpose of description and should not be regarded as limiting.

Template Module: Template modules pre-arranged layout of the multimedia information. The template modules may be categorized and sorted to provide a quick and easy operation to the user during multimedia editing process.

Template Element: Each template module includes at least one template element. The template element is composed of text message, image, motion picture, animation, audio, etc., and is capable of present hyperlink, visual effect, or other effect in response to user's operation.

Material Data: Material data are provided to user during editing process. The material data include text message, image, motion picture, animation, audio, and combinations thereof. The user may easily import, add, or delete material data from the database in the editor of the present invention.

(The template module, template element, and material data will be discussed in the detailed description.)

Template Parameter: The template parameters are provided for customized configurations of the template modules, typically related to the basic attributes of the template, such as background size, background color, background picture, and background music of the template.

Template Element Parameter: The template element parameters are provided for customized configurations of the template element in the template modules. Different kinds of template element parameters may be used. For example, the button-type element may have parameters for “button link to image,” “button link to music,” “button for visual effect to image,” etc.

Material Parameter: The material parameters are provided for customized configurations of the material data. Different kinds of material parameters may be used according to the types of material data. For example, a music-type material data may have parameters for “volume level,” “repeat play,” etc.

Preview Area: A specific area for previewing the template module and material data. It also previews the output of multimedia information.

Layout: An arrangement of display according to a predetermined rule. For example, the size or pattern of the display screen or the printout.

Interactive Area: A specific area in the template module. The template element parameter defines the interactive relationship between template element and interactive area to present an interactive effect. For example, when the user selects the template element, e.g. mouse click on the template element, the interactive area will immediately perform a predetermined response.

Image: In this specification, image, picture, photo mean static picture, including halftone, grayscale, index-colored and full-color.

Motion Picture: Sequentially display pictures to produce motion effect, such as AVI, MPEG, DAT, WMV, etc. Also called video hereinafter.

Animation: Sequentially display graphics, including manually drawn or computer generated, to produce motion effect, such as motion-GIF.

Proprietary File Format: It means the file format in a predetermined data structure for accessing by specific application. These kinds of file formats are usually defined by a private company or organization.

Pseudo-Standard File Format: It means the file format which is broadly used in public hereinafter. For example, HTML, MPEG, MP3, JPG, BMP, etc. It should be noted that some proprietary file formats also become pseudo-standardized because their high popularity, such as FLASH(SWF) file or PDF file.

FLASH file: a file format defined by Macromedia Inc. for displaying image, animation, text, etc, via vector graphics to provide high quality presentations. Flash is a commonly used multimedia file format used to create animations and advertisements, to design web-page elements, and to add video to web sites.

XML (eXtensible Markup Language): XML is a markup language for describing schematic information in an electronic document. XML is defined according to Standard Generalized Markup Language (SGML)—International Organization for Standardization (ISO) 8879:1986. XML is similar to HTML but further uses customizable tags and data structures. XML may also retrieve data from a database and then serialize the retrieved data.

### EMBODIMENTS

The present invention provides a template-based multimedia editor and editing method for producing multimedia information using a pre-defined layout of template module with various material data such that the multimedia information, e.g. digital content, may be created and applied easily, quickly and efficiently while the developing cost is also decreased.

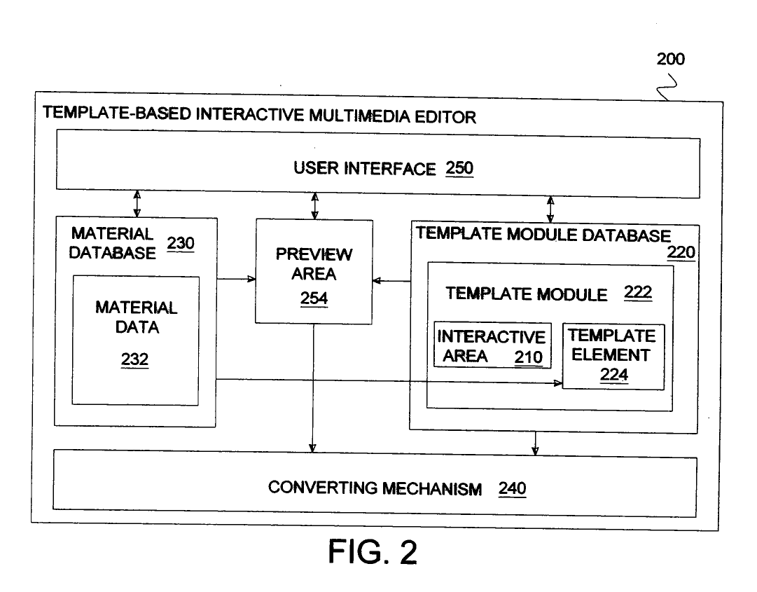

FIG. 2 is a block diagram illustrating a multimedia editor 200 in accordance with one embodiment of the present invention. The editor 200 includes a template module database 220, a material database 230, a converting mechanism 240, and a user interface 250. The template module database 220 includes at least one template module 222, and the template module 222 has an interactive area 210 and at least one template element 224. The material database 230 has at least one material data 232. The user interface 250 provides a preview area 254 for a user to edit the template module 222 and material data 232. The template module 222 includes at least one adjustable template parameter and the template element 224 has at least one adjustable template element parameter. The material data 232 has at least one adjustable material parameter. In this embodiment, editor 200 is embodied as a storage medium having program code thereon and is executed by a computer. It should be noted that, in another embodiment, the present invention may also be embodied as an electronic device embedded with required program code to perform the features and functions disclosed in the present invention

The converting mechanism is adapted to process a predetermined algorithm. The user selectively adjusts the template parameter, the template element parameter, and the material parameter via the user interface, and selectively sets the template element parameter to define an interactive relationship between the template element and the interactive area, and associates a selected material data with the preview area via a drag-and-drop operation. The converting mechanism converts the template module and the material data into multimedia information based on the predetermined algorithm.

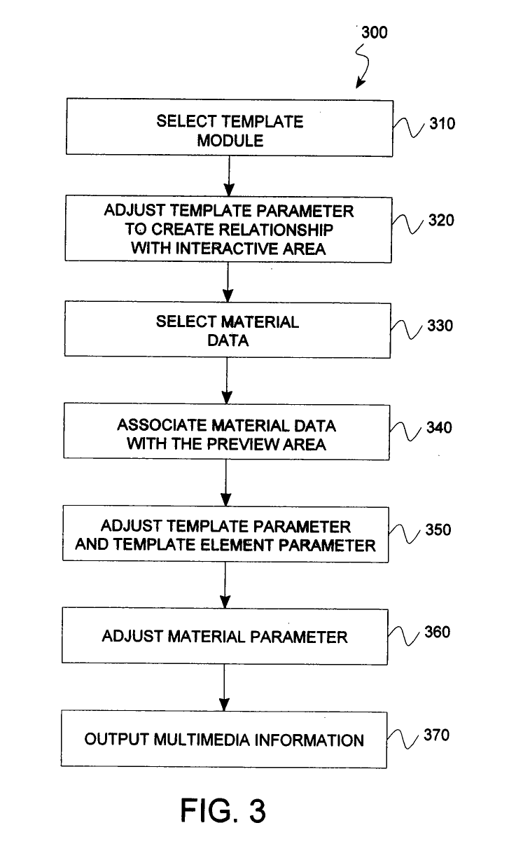

FIG. 3 is a flowchart illustrating a multimedia editing method 300 in accordance with one embodiment of the present invention. The editing method 300 shown in FIG. 3 is described hereinafter with reference to the editor 200 shown in FIG. 2. In step 310, a user selects a template module 222. In step 320, the user adjusts the template parameter and the template element parameter. In step 330, the user selects at least one material data 232. In step 340, the user associates the selected material data 232 with the preview area 254. For example, the user may perform a drag-and-drop operation to create the association via the user interface 250. In step 350, the user selectively sets the template element parameter to define an interactive relationship between the template element 224 and the interactive area 210. In step 360, the user selectively adjusts the material parameter. In step 370, multimedia information is output according to the template module 222 and the material data 232. It should be noted that the above-described steps are illustrated as an exemplary embodiment of the present invention rather than limitations. For example, some steps described above may be performed in different sequences, such as the material data 330 may be selected before the template module 310, or alternatively, both the material data 330 and template module 310 may be selected simultaneously. Further, some of the above steps are optional. Other features and characteristics will be further described in the following descriptions.

Data Structure

In one aspect of the present invention, the concept of template module is capable of integrating different data structures or formats so that a user may easily operate the multimedia editor in an interactive mode. Therefore, the data structure is used in the present invention with high compatibility, such as XML standard data structure. The objects and parameters in XML are highly customizable according to various conditions. Thus, the cost and time required to complete the work may be considerably reduced. It should be noted that the data structure is transparent to the user, i.e., the user need not realize the actual data structure; thus the editing method of the present invention may be performed in a friendly manner from the user's point of view.

Creation of Template Module

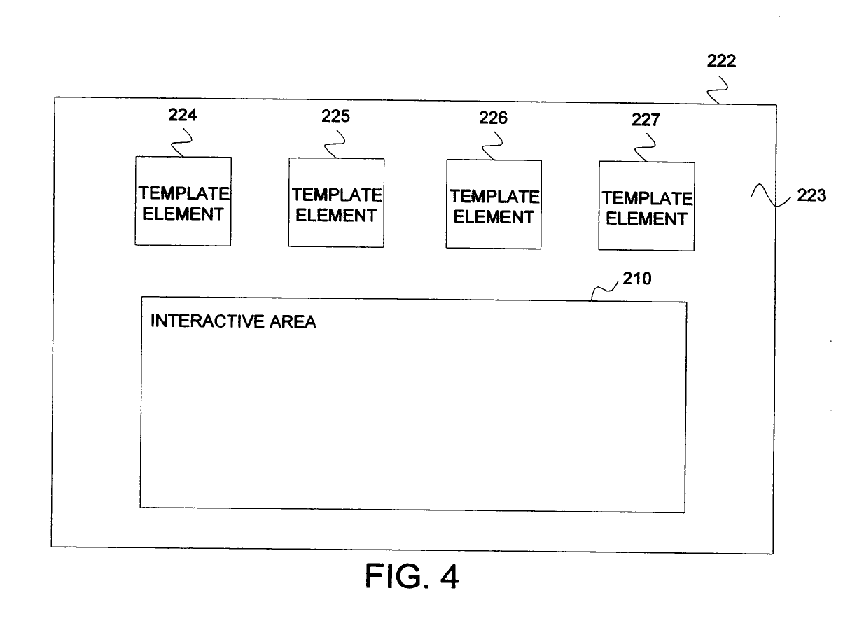

Referring to FIG. 2, the template module database 220 of editor 200 includes at least one template module 222 to be selected or edited by users. Template modules 222 are categorized and sorted based on design purpose to display various layouts. For example, the template modules 222 may be categorized based on the usage conditions, such as basic templates, interactive templates, manual templates, demonstration templates, popular templates, video player templates, etc. Each template module 222 has at least one template element 224. As shown in FIG. 4, template module 222 has an interactive area 210 and four template elements 224, 225, 226 and 227. Template module 222 may be provided with at least one template parameter for adjusting the properties of the template module 222. In this embodiment, the template parameter is used to indicate an image file for the background picture 223. In other embodiments, the template module 222 may includes other template parameters to indicate background color, background size, background music, etc. Template elements 224-227 are pictures in this embodiment, and other materials may be used in other embodiments, such as motion pictures, text messages, movie clips, etc. Each template element 224-227 includes at least one template element parameter for setting the properties of the template element 224-227, such as creating hyperlink or visual effect according to the category of the template module.

For example, when the template module 222 is a manual template, the template element parameters of template elements 224-227 may be respectively configured as “link to an image file,” “link to a website,” “link to music file,” and “link to descriptions.” Alternatively, when the template module 222 is a video player template, the template element parameters of the template elements 224-227 may be respectively configured as “volume adjustment,” “video play,” “video stop” and “video pause.” In other embodiments, the template element parameters may includes, but is not limited to, the following functionalities: “image fade in/fade out,” “picture replacement,” “element position adjustment,” element size adjustment,” or any other functions for multimedia information. In other words, each template element 224-227 of the template module 222 may be configured to an provide appropriate template element parameter on demand. Furthermore, one who skilled in the art may understand that the template module 222 of the present invention may be customized or created by users. For example, users may add customized template modules to the database for future use. It is also noted that the layout of the element module 222, such as the arrangement of template element 224-227 and interactive area 210, are also adjustable, and more or less template elements may be implemented in the template module. FIG. 4 is merely an example of the present invention and should not be considered as a limitation to the scope of the present invention.

Users may easily create their own multimedia information with various appearances with high compatibility by the template module 222 mentioned above along with the template element 224-227.

Material Data

Besides the template modules mentioned above, the material data 232 may be used in the multimedia editor 200 to enrich the content of the multimedia information. For example, the material data 232 may include text message, picture, motion picture, video, audio, etc. Editor 200 may provide some default materials for users. Also, users may still import or create other materials for future use.

User Interface

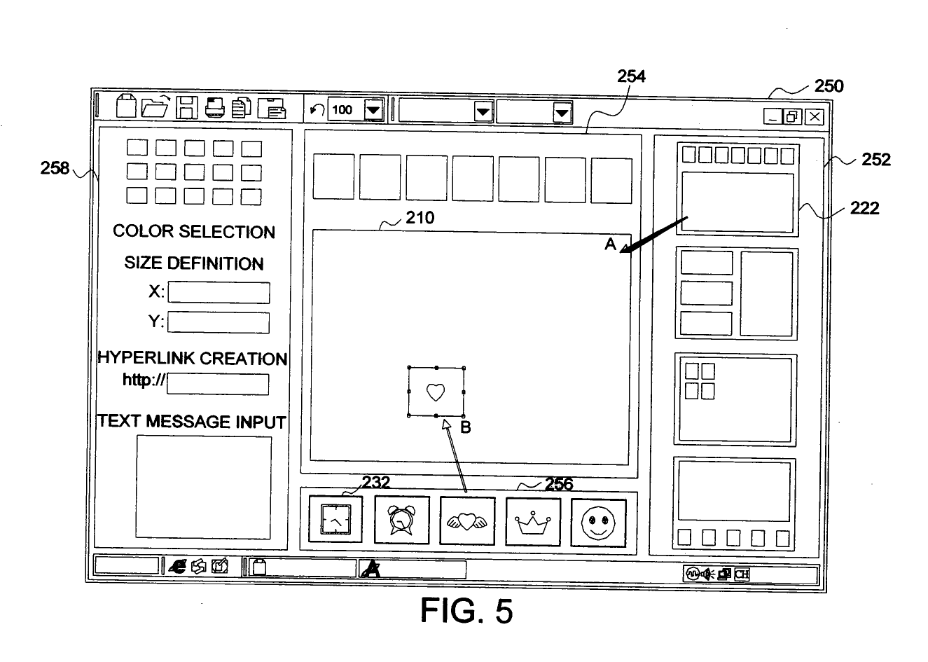

FIG. 5 shows the user interface 250 in accordance with one embodiment of the present invention. User interface 250 includes a template display area 252, a preview area 254, a material display area 256 and a configuration area 258. The template display area 252 shows the template modules 222 stored in the template module database 220 as shown in FIG.2. Referring to FIG. 5, users may choose their favorite template module 222 from the template display area 252, such as via a drag-and-drop operation (shown as arrow A) to drag the template module 222 to the preview area 254. Afterwards, the preview area 254 will display detail layout of the template module 222 for users. Material display area 256 shows the material data 232 stored in the material database 230 as shown in FIG. 2. Similarly, users may choose their favorite material data 232 from the material display area 256, such as via a drag-and-drop operation (shown as arrow B) to drag the material data 232 to the preview area 254. Users may adjust various parameters, such as template parameter, template element parameter, or material parameter, in the configuration area 258. For example, users may define the interaction relationship between template element 224 and interactive area 210 by setting or adjusting the template element parameter in the configuration area 258. The configuration area 258 shown in FIG. 5 is a general type providing all parameter configuration and adjustment. However, one who skilled in the art may understand that multiple configuration areas may be separately provided for different parameters. Alternatively, other configuration mechanisms are also available in the present invention, such as a drop-down menu, a mouse right-click menu, or any other configuration interface. Configuration area 258 in FIG. 5 shows some examples of adjustable parameters, such as color selection, size definition, hyperlink creation, and text message input. It is also noted that the layout of the user interface may have other modifications and is not limited to the exemplary embodiment shown in FIG. 5.

Converting Mechanism

When the template module 222 and material data 232 is edited and displayed in the preview area as described above, the converting mechanism 240 converts them into a multimedia information via a predetermined algorithm. The predetermined algorithm is chosen according to the output file format. For example, the editor 200 outputs a FLASH file, which is a file format broadly used on Internet, by means of the converting mechanism 240 so that the multimedia information produced by the editor 200 is highly compatible. Alternatively, the editor 200 may output a proprietary file format for a specific purpose. It should be noted that the data structure is highly compatible, such as the XML standard format, so that the present invention is implemented with flexibility and compatibility.

Editing Stage

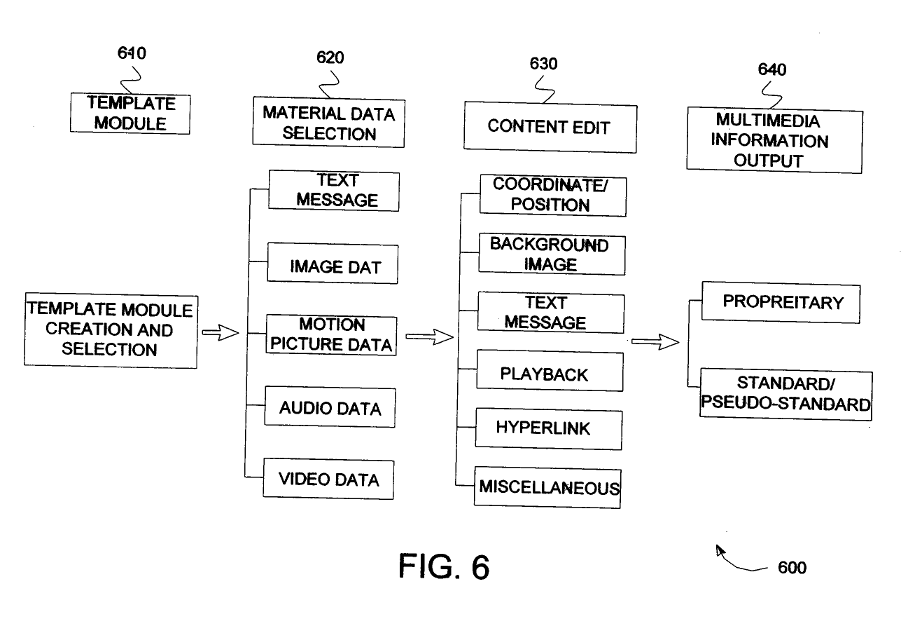

FIG. 6 is a flowchart illustrating a multimedia editing method in accordance with another embodiment of the present invention. In FIG. 6, the present invention is roughly described as four stages, i.e. template selection stage 610, material data selection stage 620, content editing stage 630, and multimedia information production stage 640. In the first stage 610, the template modules are created as described above. The template modules may be provided in advance or created by user. The user may select the template module on demand. In the second stage 620, the user selects the material data. The material data may include text messages, pictures, motion pictures, audio files, and video files.

In the third stage 630, the data structure with high compatibility is implemented and the user may configure various parameters as follows: (1) setting position or coordinate value to define and arrange layout; (2) setting background appearance to define a background picture or a background color; (3) modifying text message to define the text size, text font, text color, etc; (4) setting playback time to define the start time, end time, shuffle play, random play, repeat/cycling play, etc; (5) setting hyperlink to other websites or image, file, music, etc for real-time interaction; (6) setting miscellaneous configuration. The above-descriptions show merely exemplary embodiments and many other parameters may be configured in the present invention, such as movement path of objects in the interactive area, volume level, image fade in/fade out, zoom in/zoom out, rotation, movement, flip, etc.

In the fourth stage 640, the multimedia information is outputted or saved. For example, the multimedia information may be outputted or saved as a proprietary file format or a standard/pseudo-standard file format, such as AVI, MP3, WMV, MOV, SWF, XML, and MPG files. It should be noted that four stages described above are exemplary implementations rather than limitations. The present invention is not limited to the performing sequence described above. Contrarily, there are a lot of configuration and selection sequences to perform the edit process. For example, the background image selection and the template module selection may be performed at the same time, or the multimedia information may be outputted or saved during any time point of the edit process.

It should be understood that the preferred embodiment has been presented by way of example only, but not limitation. Thus, the breadth and scope of a preferred embodiment should not be limited by any of the aforementioned exemplary embodiments, but should be defined only in accordance with the following claims and their equivalents.

What is claimed is:

1. A template-based multimedia editing method, comprising:
selecting a template module, the template module including:
at least one adjustable template parameter;
an interactive area; and
at least one template element having at least one adjustable template element parameter;
selecting at least one material data having at least one adjustable material parameter;
associating the selected material data with a preview area;
selectively adjust the template parameter and the template element parameter;
selectively setting the template element parameter to define an interactive relationship between the template element and the interactive area;
selectively adjusting the material parameter; and
outputting a multimedia information according to the template module and the material data.

2. The method according to claim 1, wherein the template module is selected from a template module database, the template module database includes at least one template module, and each template module is pre-categorized according to the template element of the template module.

3. The method according to claim 1, wherein the template parameter of the template module is selected from a group consisting of a background size, a background color, a background pattern, and a background music.

4. The method according to claim 1, wherein the material data includes text data, and the material parameter includes at least one of a text position, a text size, a text color, and a zooming factor.

5. The method according to claim 1, wherein the material data includes static pictures, and the material parameter includes at least one of a picture position and a picture size.

6. The method according to claim 1, wherein the material data includes motion pictures, and wherein the material parameter includes at least one of a picture position, a picture size, a zooming factor, a start time, an end time, and a repeat indicator.

7. The method according to claim 1, wherein the material data includes video data, and wherein the material parameter includes at least one of a video position, a video size, a zooming factor, a start time, an end time, and a repeat indicator.

8. The method according to claim 1, wherein the material data includes audio data, and wherein the material parameter includes at least one of a volume level, an audio format, a start time, an end time, and a repeat indicator.

9. The method according to claim 1, wherein the material data includes a text data, a static picture, a motion picture, a video data, an audio data, and combinations thereof.

10. The method according to claim 1, wherein the template module is based on Extensible Markup Language (XML) format.

11. The method according to claim 1, further comprising a step of forming the multimedia information in a proprietary file format.

12. The method according to claim 1, further comprising a step of forming the multimedia information in a pseudo-standard file format, wherein the pseudo-standard file format includes AVI, MP3, WMV, MOV, SWF, XML, and MPG files.

13. A template-based multimedia editor comprising:
a template module, including:
at least one adjustable template parameter;
an interactive area; and
at least one template element having at least one adjustable template element parameter;
a material database including at least one material data, each material data having at least one adjustable material parameter;
a converting means for processing a predetermined algorithm; and
a user interface providing a preview area for a user to edit the template module and the material data;
wherein the user selectively adjusts the template parameter, the template element parameter, and the material parameter via the user interface, and selectively sets the template element parameter to define an interactive relationship between the template element and the interactive area, and associates a selected material data with the preview area via a drag-and-drop operation, and wherein the converting means converts the template module and the material data into a multimedia information based on the predetermined algorithm.

14. The editor according to claim 13, wherein the template module is selected from a template module database, the template module database includes at least one template module, and each template module is pre-categorized according to the template element of the template module.

15. The editor according to claim 14, wherein the category of template module comprises a basic group, interactive group, popular group, and video playback group.

16. The editor according to claim 13, wherein the template element parameter includes at least one of an element position, an element size, a link to static picture, a link to audio data, and a link to video data, and a playback indicator.

17. The editor according to claim 13, wherein the template parameter includes at least one of a background size, a background color, a background pattern, and a background music.

18. The editor according to claim 13, wherein the multimedia information is presented in a proprietary file format.

19. The method according to claim 13, wherein the multimedia information is presented in a pseudo-standard file format, and wherein the pseudo-standard file format includes AVI, MP3, WMV, MOV, SWF, XML, and MPG files.

20. A computer readable medium including a program code for editing multimedia data, the program code being processed by a computer to perform the following steps:
selecting a template module, the template module including;
at least one adjustable template parameter;
an interactive area; and
at least one template element having at least one adjustable template element parameter;
selecting at least one material data having at least one adjustable material parameter;
associating the selected material data with a preview area;
selectively adjusting the template parameter and the template element parameter;
selectively setting the template element parameter to define an interactive relationship between the template element and the interactive area;
selectively adjusting the material parameter; and
outputting a multimedia information according to the template module and the material data.
